(19) United States
(12) Patent Application Publication
(10) Pub. No.: US 2009/0150158 A1
(43) Pub. Date: Jun. 11, 2009

(54) Portable Networked Picting Device

(76) Inventors: Craig H. Becker, Austin, TX (US); Leugim A. Bustelo, Austin, TX (US)

Correspondence Address: IBM CORPORATION (JVM), C/O LAW OFFICE OF JACK V. MUSGROVE, 2911 BRIONA WOOD LANE, CEDAR PARK, TX, 78613, US

(21) Appl. No.: 11/951,378

(22) Filed: Dec. 6, 2007

(51) Int. Cl. G10L 11/00; G10L 15/00

(52) U.S. Cl. 704/270; 704/231; 2/69

(57) ABSTRACT

A portable picting device automatically converts an audio signal from a microphone into a digital data stream, parses a series of words from the digital data stream, and detects any words that match tags in a tag/image database. An image corresponding to the matching tag(s) is then retrieved and transmitted to a display. The images may be stored on a remote network, such as the Internet. In the illustrative embodiment the display is integrated into an article of clothing such as a shirt.

### BACKGROUND OF THE INVENTION

1. Field of the Invention

The present invention generally relates to display and presentation systems, and more particularly to a portable display unit worn as attire which can automatically display stored images based on voice recognition of associated tags.

2. Description of the Related Art

Rapid advances in display technology have greatly simplified and enhanced the ability of any speaker to successfully communicate ideas, whether for business or pleasure. Gone are the days of cathode ray tubes and overhead projectors; these relics have been replaced by liquid crystal display (LCD) or light-emitting diode (LED) panels, plasma (electroluminescent) screens, and compact electronic projectors that can operate alone or in tandem with advanced presentation software running on a notebook computer. It has become a fairly straightforward matter for anyone with minimal computer proficiency to create and present electronic slides using a computer and portable projection device.

One problem that has grown out of these technologies is the difficultly in managing a large number of electronic slides or pictures. A photographer or graphic artist might have thousands of images in their portfolio. Family albums with hundreds of photos and clippings are also now turning electronic. Images can be managed by indexing them in a database with parameters regarding their creation, then using a search engine to query the database and retrieve images having parameters which match the search criteria; see for example U.S. Pat. No. 6,504,571. However, this approach can be cumbersome and time-consuming. A more intuitive approach to image management is the use of tags that are associated with the content of the images, as exemplified at the popular photo sharing Internet site “flickr” (http://www.flickr.com/). A user can assign multiple tags (keywords or category labels) that allow later searching to find photos having some commonality. Up to 75 tags can be assigned to each photo, and users can search for multiple tags.

The medium supporting the display device is also evolving. Display devices have been integrated into a wide variety of products, including hand-held devices such as music players or telephones, larger objects such as vehicles, and even architectural features. Clothing can be also used as a display. Patent Cooperation Treaty Publication no. WO2004036891 discloses a flexible display unit which is attached to the front of a shirt. The display unit is responsive to a wireless communication device such as a cellular telephone and displays text or an image associated with an input from the wireless communication device. The input may be a signal stream of video data. While that publication contemplates a display unit in the form of an LCD, LED or plasma panel, there are newer technologies that allow the actual fibers of the shirt to become the display device; see an example at http://gizmodo.com/gadgets/ifa2007/ghosts-chase-pac-man-across-my-chest-295936.php.

In spite of these advances, it can still be difficult to select and present desired images on-the-fly, that is, without prior preparation. It is also problematic for a speaker to deviate from a planned presentation. Visual presentations are generally linear, and if a speaker wants to jump ahead in the discussion or change to a different topic, she must take the time to sequence through a set of slides or load a different electronic presentation, adversely impacting the effectiveness of the communication style. It would, therefore, be desirable to devise an improved electronic display system which could more effortlessly depict images associated with a presentation or discussion. It would be further advantageous if the system could be portable and yet still powerful, that is, capable of selecting from a very large number of images.

### SUMMARY OF THE INVENTION

It is therefore one object of the present invention to provide an improved portable display system that can be used to enhance a presentation or discussion.

It is another object of the present invention to provide such a display system that can intuitively access a large number of visual images.

It is yet another object of the present invention to provide a mobile device that displays images in a flexible fashion without regard to a prior planned sequence.

The foregoing objects are achieved in a picting device generally comprising a display, a microphone, and a microprocessor which automatically converts the audio signal from the microphone into a digital data stream, parses a series of words from the digital data stream, detects that one or more of the words match a tag in a tag/image database, retrieves an image corresponding to the matching tag, and transmits the image to the display. Multiple tags can be associated with an image link in the tag/image database. The picting device may require a threshold number of words that match the associated tag before retrieving the image. The tags can also be assigned different weightings, and the picting device will select the image whose matching tags (over a period of time) have the highest overall weighting. The images may be stored on a remote network, such as the Internet, in which case the microprocessor retrieves the images using a wireless modem. In the illustrative embodiment the display is integrated into an article of clothing such as a shirt.

The above as well as additional objectives, features, and advantages of the present invention will become apparent in the following detailed written description.

### BRIEF DESCRIPTION OF THE DRAWINGS

The present invention may be better understood, and its numerous objects, features, and advantages made apparent to those skilled in the art by referencing the accompanying drawings.

FIG. 1 is a perspective view of a person wearing a shirt which is part of a display system constructed in accordance with the present invention wherein the shirt has an integrated display device;

FIG. 2 is a block diagram of a portable picting device in accordance with one embodiment of the present invention;

FIG. 3 is a block diagram of a computer workstation programmed to support the portable picting device in accordance with one implementation of the present invention;

FIG. 4 is a flow chart illustrating programming of the portable picting device in accordance with one implementation of the present invention; and

FIG. 5 is a flow chart illustrating operation of the portable picting device in accordance with one implementation of the present invention.

The use of the same reference symbols in different drawings indicates similar or identical items.

### DESCRIPTION OF THE PREFERRED EMBODIMENT(S)

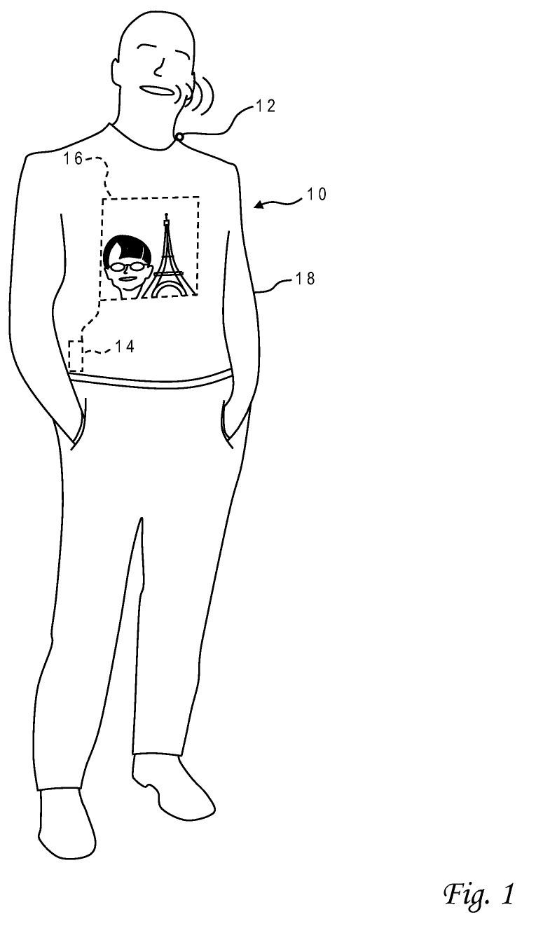

With reference now to the figures, and in particular with reference to FIG. 1, there is depicted one embodiment 10 of a portable picting device (pictor) constructed in accordance with the present invention. Picting device 10 is generally comprised of a microphone 12, a programmable microprocessor 14, and a display device 16 which is attached to or integrated with a garment. In this example display device 16 presents an image at a central area on the front of a shirt 18. Display device 16 may take many forms such as an LCD panel, an LED panel, a plasma screen, or interwoven optical fibers, and is preferably flexible to conform to the wearer's body like normal clothing. While display device 16 is shown as part of shirt 18, it is understood that other garments may possess this feature including, without limitation, pants, shorts, skirts, gloves, socks, undergarments, jackets, coats, and hats.

Microprocessor 14 automatically extracts visual images from a local or remote collection based on voice recognition of keywords picked up by microphone 12 from continuous speech, and transmits the images to display device 16. For example a proud grandparent might wear a shirt with an integrated display that brings up a picture of their grandchild with the Eiffel tower in the background after the grandchild's name is spoken in conversation proximate with the words “Paris” or “France.” In an alternative embodiment wherein the image is shown on a smaller hand-held display, a desperate and language-challenged tourist seeking a restroom in a foreign land might be more successful in finding relief if the device began displaying random pictures of toilets while they attempted to communicate with a storekeeper. While these are more personalized applications of the present invention, there are commercial uses as well. An individual can become a walking, talking advertisement for a plethora of goods and services. The automatic generation of images that are specific to a spontaneous discussion is also useful in augmenting a business or technical presentation. The garment version of the present invention may be used as the sole display of the presentation, or as an adjunct to a larger main display.

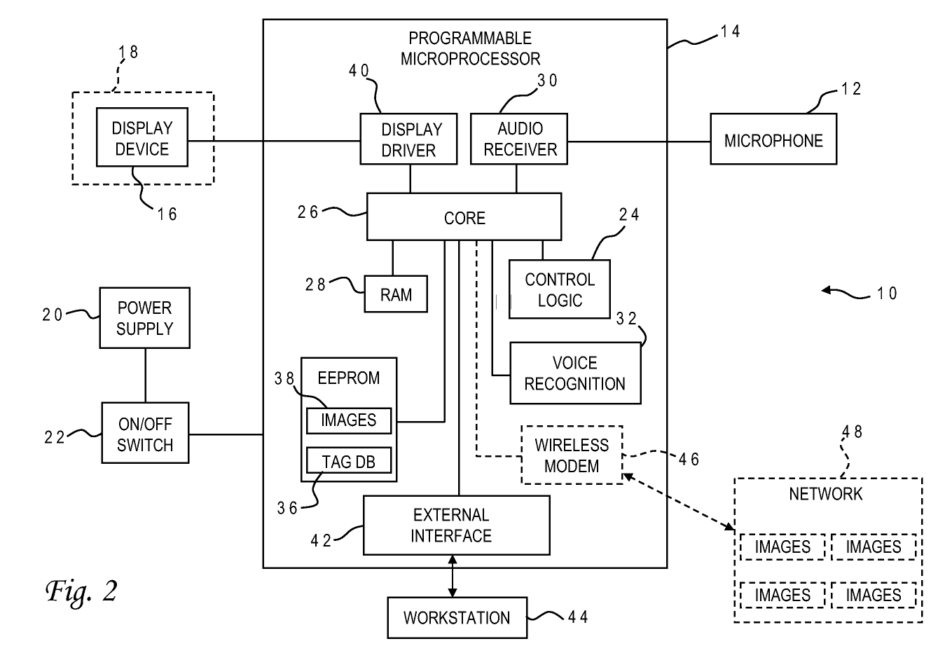

Referring now to FIG. 2, programmable microprocessor 14 of picting device 10 is shown in further detail. Programmable microprocessor 14 includes one or more integrated circuits that may be custom made or fabricated from an application-specific integrated circuit (ASIC). Electrical power for programmable microprocessor 14 is provided by a power supply 20, e.g., a battery that is stored in the same housing as programmable microprocessor 14. A manual on/off switch 22 connected to power supply 20 is used to turn on programmable microprocessor 14. Control logic 24 includes program instructions which are carried out in accordance with the present invention by a processor core 26. Core 26 uses random-access memory (RAM) 28 in carrying out the program instructions, and is connected to an audio receiver 30 which receives a continuous audio input from microphone 12. Microphone 12 may be connected to audio receiver 30 using a wire, or may include its own battery and antenna for wireless connectivity. A clip on microphone 12 allows for the removable attachment to shirt 18. Audio receiver 30 may include various filters and an analog-to-digital converter to provide a digital data stream to core 26.

The data stream from audio receiver 30 is analyzed by core 26 using conventional voice recognition logic 32 to parse a series of words spoken in conversation by the user (or someone else nearby). The voice recognition logic may include training sets for the user to establish word patterns. These words are compared to tags (keywords) in a tag database 36. Tag database 36 is stored in electronically-erasable, programmable read-only memory (EEPROM). The tags are associated by the database with filenames for images 38 that may be stored in EEPROM. As core 26 detects the occurrence of tags in database 38, it retrieves corresponding image files and forwards them to a display driver 40. Display driver 40 transmits a video signal for the selected image to display device 16. The connection between display driver 40 and display device 16 may also be wireless, in which case programmable processor 14 does not need to be carried by the user but can instead be placed anywhere within the communication range of microphone 12 and display device 16. Core 26 is further connected to an external interface 42 to allow programming by a workstation 44. Core 26 is shown directly connected to the various components of microprocessor 14 but the microprocessor design may instead utilize one or more system interconnect buses for transferring data between the components with bus arbitration.

In an alternative implementation, programmable microprocessor 14 includes a wireless modem 46, and the images 38 are stored in a remote computer network 48, such as the Internet. Each image link in tag database 38 is an address for the remotely stored image, such as a universal resource locator (URL) address, and the retrieval request and responsive image transmission are carried out using conventional communications protocols. The images linked by tag database 38 can be physically stored on different servers. This implementation requires only the more compact tag database to be locally stored with virtually limitless capacity for the images themselves (the tag database can also be located remotely).

Those skilled in the art will further appreciate that the present invention encompasses the use of non-programmable microprocessors, but the provision of a programmable microprocessor further allows updating of control logic 32 and voice recognition software 32.

Different criteria may be established in control logic 24 to decide how to select images based on the detected tags. There can be a preset threshold for the number of times a tag is spoken (or the number of times it is spoken in a given time period) before an associated image is retrieved. Tags can additionally be given different weightings in case multiple tags are spoken in a single conversation, i.e., the image having the highest weighting is selected. This formula can include multiple tag matches for a single image, and the same tag can be used with different weightings for different images. For example, the user might be able to assign a weighting of 1 to 100 to each tag, with a default weighting of 1. When different tags having entries in tag database 38 are detected over a short period of time, there might be several hits (different corresponding images) but only one that has a high weighting, e.g., 100, will be selected even over another image which has several matching tags of low weight.

The selected image can be displayed for some minimum amount of time, some maximum amount of time, or until the retrieval criteria are next met (or some combination of the foregoing).

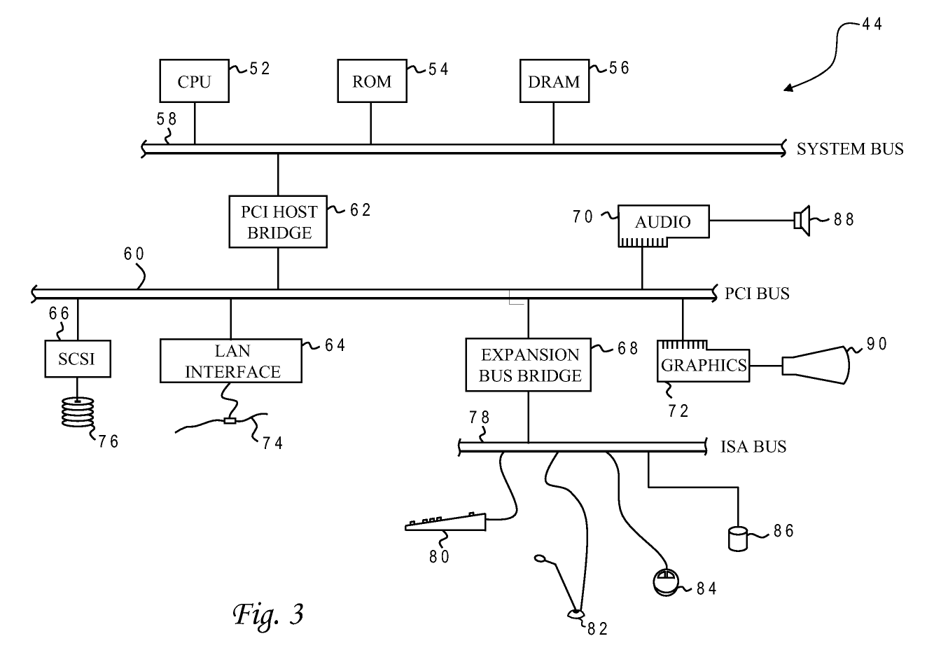

The images and tag database can be uploaded to programmable microprocessor 14 using the workstation 44 shown in FIG. 3. Workstation 44 includes a central processing unit (CPU) 52 which carries out program instructions, firmware or read-only memory (ROM) 54 which stores the system's basic input/output logic, and a dynamic random access memory (DRAM) 56 which temporarily stores program instructions and operand data used by CPU 52. CPU 52, ROM 54 and DRAM 56 are all connected to a system bus 58. There may be additional structures in the memory hierarchy which are not depicted, such as on-board (L1) and second-level (L2) caches. In high performance implementations, workstation 44 may include multiple CPUs and a distributed system memory.

CPU 52, ROM 54 and DRAM 56 are coupled to a peripheral component interconnect (PCI) local bus 60 using a PCI host bridge 62. PCI host bridge 62 provides a low latency path through which processor 52 may access PCI devices mapped anywhere within bus memory or I/O address spaces. PCI host bridge 62 also provides a high bandwidth path to allow the PCI devices to access DRAM 56. Attached to PCI local bus 60 are a local area network (LAN) adapter 64, a small computer system interface (SCSI) adapter 66, an expansion bus bridge 68, an audio adapter 70, and a graphics adapter 72. LAN adapter 64 may be used to connect computer system 44 to an external computer network 74, such as the Internet. A small computer system interface (SCSI) adapter 66 is used to control high-speed SCSI disk drive 76. Disk drive 76 stores the program instructions and data in a more permanent state, including the images and the program which uploads the images and tag database to picting device 10. Expansion bus bridge 68 is used to couple an industry standard architecture (ISA) expansion bus 78 to PCI local bus 60. As shown, several user input devices are connected to ISA bus 78, including a keyboard 80, a microphone 82, and a graphical pointing device (mouse) 84. Other devices may be attached to ISA bus 78, such as a CD-ROM drive 86. Audio adapter 70 controls audio output to a speaker 88, and graphics adapter 72 controls visual output to a display monitor 90.

The illustrative implementation provides program instructions for pictor programming on disk drive 36. The program instructions may be written in the C++ programming language for an AIX environment. Workstation 44 may also carry out program instructions for creating or managing the images. Accordingly, a workstation supporting the invention may include conventional aspects of various presentation tools, and these details will become apparent to those skilled in the art upon reference to this disclosure.

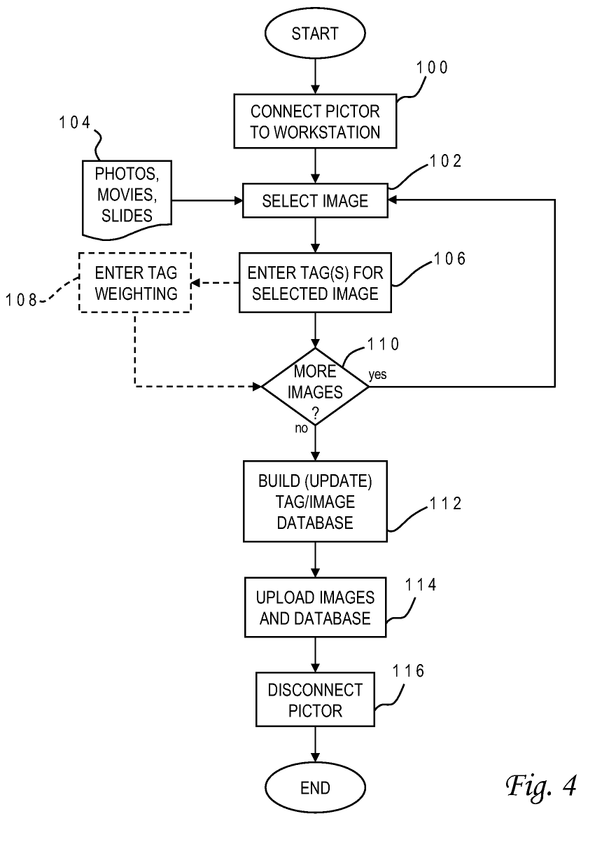

Workstation 44 can be used to construct tag database 38 as illustrated in FIG. 4. The picting device is first connected to the workstation (100). This connection is achieved using conventional physical connectors and connection protocols such as the universal serial bus (USB), or can be wireless (infrared or radio wave). Once the connection is established, the first image to be processed is selected (102). The images may for example be photographs, movies, or electronic slides. The images can be stored on a separate medium and downloaded to the workstation (104). The user then enters one or more tags for the selected image (106). If desired the user can optionally assign a weighting to each tag (108). In the illustrative embodiment the user can assign up to 100 tags for a given image. The size of the database (i.e., the number of images linked) is limited only by the amount of available memory (EEPROM). If there are more images to be added (110), the process repeats at step 102. Once the user has assigned tags to all of the selected images, workstation 44 builds (or updates) the database (112). The database file and images are then uploaded to the picting device (114), and the picting device is disconnected (116).

In lieu of programming via a general-purpose computer such as workstation 44, programmable microprocessor 46 may have its own (on-board) operating system including program instructions which allow the user to build and upload the database using a special-purpose console that is temporarily connected to the microprocessor.

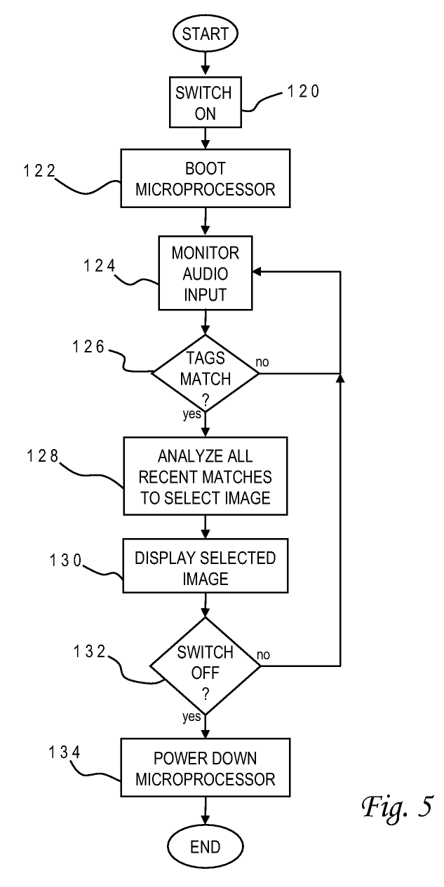

The invention may further be understood with reference to the flow chart of FIG. 5 which illustrates the operation of picting device 10. Operation begins when the user turns on the power switch (120). The microprocessor begins a startup routine (boots) using instructions from the control logic (122). Thereafter the microprocessor monitors the continuous audio input from the microphone (124) until it detects that a parsed word matches a tag in the database (126). If there is any match (or a match that satisfies other retrieval criteria), the control logic selects the corresponding image (128), and the image is displayed on the display unit (130). The audio input continues to be monitored at step 114 until the power switch is turned off (132) and the microprocessor powers down (134).

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. For example, the invention has been disclosed in the context of a garment having the display, but the display could be integrated with other portable objects, such as a book cover, or be a stand-alone display unit. It is therefore contemplated that such modifications can be made without departing from the spirit or scope of the present invention as defined in the appended claims.

What is claimed is:

1. An automated presentation method carried out by a microprocessor, comprising:
receiving an audio signal generated by a user;
processing the audio signal using voice recognition logic to parse a series of words;
detecting that one or more of the words match at least one tag in a tag/image database;
responsive to said detecting, retrieving an image associated with the tag; and
displaying the image on a display device proximate to the user.

2. The method of claim 1 wherein multiple tags are assigned to at least one image link in the tag/image database.

3. The method of claim 1 wherein said retrieving is further responsive to detecting a threshold number of the words that match the tag.

4. The method of claim 1 wherein:
each tag in the tag/image database is assigned a weighting; and
said retrieving selects an image associated with the tag that has a highest weighting.

5. The method of claim 1 wherein:
the image is stored in a remote network; and
said retrieving retrieves the image from the remote network using wireless communications.

6. A microprocessor comprising:
a processor core which processes program instructions;
an audio receiver which converts an audio signal generated by a user into a digital data stream;
voice recognition logic which parses a series of words from the digital data stream;
a tag/image database having image links with associated tags;
control logic which compares the words to tags in said tag/image database and retrieves an image corresponding to at least one matching tag; and
a display driver which transmits a video signal of the image to a display proximate to the user.

7. The microprocessor of claim 6 wherein multiple tags are assigned to at least one image link in said tag/image database.

8. The microprocessor of claim 6 wherein said control logic retrieves the image when a threshold number of the words match the matching tag.

9. The microprocessor of claim 6 wherein:
each tag in said tag/image database is assigned a weighting; and
said control logic retrieves an image associated with the tag that has a highest weighting.

10. The microprocessor of claim 6 wherein the microprocessor is programmable, and further comprising an external interface for connecting the microprocessor to a workstation which uploads said tag/image database.

11. The microprocessor of claim 6, further comprising a wireless modem which is used by said control logic to retrieve the image from a remote network.

12. A portable picting device comprising:
a display device;
an audio input device proximate said display device which produces an audio signal from spoken conversation; and
a microprocessor which automatically converts the audio signal into a digital data stream, parses a series of words from the digital data stream, detects that one or more of the words match at least one tag in a tag/image database, retrieves an image corresponding to the matching tag, and transmits the image to said display device.

13. The portable picting device of claim 12 wherein said display device is part of an article of clothing.

14. The portable picting device of claim 12 wherein said microprocessor retrieves the image from a remote network.

15. The portable picting device of claim 14 wherein:
the image is one of a plurality of images stored on different servers of the remote network; and
the tag/image database includes addresses of the remote network linking tags to the plurality of images.

16. A computer program product comprising:
a computer-readable medium; and
program instructions residing in said medium for processing an audio signal generated by a user using voice recognition logic to parse a series of words, detecting that one or more of the words match a tag in a tag/image database, retrieving an image associated with the tag, and transmitting the image to a display driver of a display proximate to the user.

17. The computer program product of claim 16 wherein multiple tags are assigned to at least one image link in the tag/image database.

18. The computer program product of claim 16 wherein said program instructions retrieve the image after detecting a threshold number of the words that match the tag.

19. The computer program product of claim 16 wherein:
each tag in the tag/image database is assigned a weighting; and
said program instructions select an image associated with the tag that has a highest weighting.

20. The computer program product of claim 16 wherein the tag/image database includes addresses of a remote network linking tags to a plurality of images.
